(19) United States
(12) Patent Application Publication
(10) Pub. No.: US 2011/0199483 A1
(43) Pub. Date: Aug. 18, 2011

(54) METHOD FOR CONTROLLING A VIDEO MONITORING DEVICE

(75) Inventors: Anatoli Stobbe, Barsinghausen (DE); Thomas Gries, Barsinghausen (DE)

(73) Assignee: ASTRA Gesellschaft fuer Asset Management mbH & Co. KG, Barsinghausen (DE)

(21) Appl. No.: 12/998,147

(22) PCT Filed: Oct. 1, 2009
(86) PCT No.: PCT/DE2009/001369

§ 371 Date: Mar. 22, 2011

(30) Foreign Application Priority Data
Oct. 3, 2008 (DE) 10 2008 058 671.4

(51) Int. Cl. H04N 7/18

(52) U.S. Cl. 348/143; 348/E07.085

(57) ABSTRACT

The invention relates to a method for controlling a video monitoring device comprising at least one digital camera, an event sensor, an illumination adaptation device having at least one light source, and an Ethernet connection. The light source is provided with energy by means of a rechargeable battery, a battery, a remote feed, or the Ethernet connection, and is switched on and off in a pulsed manner by a control circuit of the digital camera. The on and off switching pulses are synchronized with an illumination phase within the image changing period of the digital camera.

The invention relates to a method for controlling a video monitoring device according to the preamble of claim 1.

Video monitoring devices are used for remotely monitoring objects during the day and the night. In order to be able to safely evaluate the pictures transmitted from the video monitoring device an optimal image quality is required which means that exposure of the images has to be optimal.

At the same time it is desirable to maintain a low energy demand if a mains supply is not available.

The invention is based on the requirement to provide a method for controlling a video monitoring device such that an optimal image quality is realised for all possible environmental light conditions whilst keeping energy demand as low as possible.

This requirement is met for a method according to the preamble of claim 1 through the characteristics of this claim.

Further developments and advantageous designs are outlined in the sub-claims.

With the method according to the invention the especially energy-intensive light source for exposure during the night is supplied with energy from an accumulator, a battery, via a remote feed or via the Ethernet connection of the video monitoring device. The specifications for the supply of energy via Ethernet connections (power over Ethernet) specify an average supply power of 12.95 watts and a maximum supply power of 15.4 watts as a basis. However this amount of power would be insufficient for the energy-intensive supply of a continuously operated light source, in order to also illuminate objects at an increased distance from the camera for sufficient exposure of the images captured by the camera.

By means of the method according to the invention it is possible, through pulsed on- and off-switching of the light source, to provide for sufficient illumination of the objects to be captured without exceeding the average or maximum power of the accumulator, battery, remote feed or of the energy transmitted via the Ethernet connection. To this end the switching-on and switching-off pulses are synchronised with an exposure phase within the image changing period of the digital camera so that the light source is always activated during the period of the exposure phase. During the remaining time, however, in which the image data stored in the image sensor of the digital camera are retrieved and processed, the light source is switched off. The energy made available is therefore used only during the period in which an actual exposure takes place, resulting in a substantially higher efficiency being achieved than would be the case if the light source were to remain switched on also during the usual time in which it is not used. Also for energy transmission over long distances, called remote feed, if current consumption is high, the drop in voltage is correspondingly high which would lead to non-functioning of the connected device.

According to a further development the control circuit of the digital camera will permit ascertaining a light quantity required for a high-contrast shot in at least one selected image section and simultaneously activating a number of light sources ascertained for controlling the required light quantity from a total number of light sources and switching them on and off in a pulsed fashion.

In this case the light quantity may be metered proportionally to the number of simultaneously activated light sources. The light sources themselves, for example light-emitting diodes, may be operated in their optimal working point because a maximum level of efficiency of the light yield exists in relation to the electrical energy used.

According to a further development the useful lives of the light sources may be adjusted to one another in that activation of the light sources, for less than the total number of simultaneously activated light sources, is distributed evenly in turn among all light sources of the total number.

In this way an even load on all existing light sources of the total number of light sources is achieved, thereby obviating a premature failure or impairment of the output of individual light sources.

The switching-on pulse duration of the light sources may be equal to the duration of the exposure phase within the image changing period of the digital camera.

In this way it is possible, even with slow camera processors which are unable to provide an exact beginning and end of an exposure phase, for the switching-on pulse duration and the exposure phase to substantially coincide as regards time.

The control circuit of the digital camera is instrumental in ascertaining a light quantity required for a high-contrast shot in at least one selected image section and therefrom a pulse-pause ratio dimensioned for achieving the required light quantity between switching-on and switching-off pulses of the at least one light source, whereby the switching-on pulse duration of the light sources is shorter than the duration of the exposure phases within the image changing period of the digital camera.

This variant makes it possible to control almost steplessly the required light quantity by adapting the pulse-pause-ratio of the switching-on duration of the light sources, and thus to optimise the energy efficiency as well as the life of the light sources.

According to a further development the required light quantity may be ascertained by evaluating the contrast of the at least one image section of previously captured images.

In this way it is ensured that the selected image section, in which for example a particularly relevant event may take place in terms of monitoring, can be optimally exposed in a timely manner so that, in the ideal case, it can be evaluated without any further editing.

In case the required light quantity is exceeded, this light quantity can be reduced by reducing means from the set of apertures and filters, in that individual reducing means or a combination of reducing means are mechanically inserted partially or wholly into the path of the rays of the at least one digital camera by means of actuators controlled by the control circuit of the at least one digital camera.

Where the light quantity exceeds the required light quantity, this may be due to direct irradiation of sunlight, which for example is dampened by a grey filter, or even due to partial irradiation due to reflections from reflecting surfaces or due to artificial or natural light sources which would irradiate only a part of the image.

According to a further development several images can be additionally captured with a light quantity differing from the required light quantity and stored in a buffer of the camera. Then an image resulting from the buffered images may be generated in that overexposed and underexposed image sections of individual images are replaced by high-contrast image sections from other images.

In this way it is possible to produce an overall image in which there are no longer any overexposed or underexposed areas but where a consistent contrast for identifying all details exists.

Furthermore at least one internal event sensor and/or an external event sensor which is arranged close to a presumed event location within the selected image section can be used, as an event occurs, to place the at least one digital camera from an energy-saving non-operating state into an operating state and, at the end of the event, to return it to the non-operating state with or without a time delay.

Furthermore the control circuit may be used, after placing the at least one digital camera into the operating state, for carrying out an image analysis of the event and maintaining the operating state if the event is confirmed, whilst, if the event is not confirmed, the digital camera is placed into the non-operating state.

With the help of these measures it is possible to further lower the total energy demand in that the energy-intensive components of the video monitoring device are activated and, as required, kept in operation only if events occur which are relevant for monitoring. Due to arranging the external event sensors at presumed event locations, purposeful monitoring is ensured and unnecessary activation possibly triggered through other disturbances is avoided.

The events which can be evaluated may be those resulting from the set of brightness changes, acoustic changes, temperature changes and movements.

By adjusting the use of physical changes to suit possible relevant events, the selection of events relevant to monitoring can be improved and unnecessary activations of the digital camera can be avoided.

Furthermore the control circuit may be used, depending upon the respective environmental brightness captured by a sensor, to select, from the at least one digital camera, a digital black-and-white camera for low environmental brightness or a digital colour camera for high environmental brightness.

Colour cameras as such provide more data than black-and-white cameras, but require a higher environmental brightness than black-and-white cameras. In order to achieve an image reproduction which is optimal for the respective light conditions, the two digital types of camera are switched from one to the other, wherein the sensor capturing the environmental brightness makes sure that only the environmental brightness forms a change-over criterion, and not the light from a light source incidentally falling into the range covered one of the two cameras.

In addition power peaks of light sources and/or actuators may be buffered by an accumulator or a capacitor.

The invention will now be described by way of an embodiment pictured in the drawing, in which

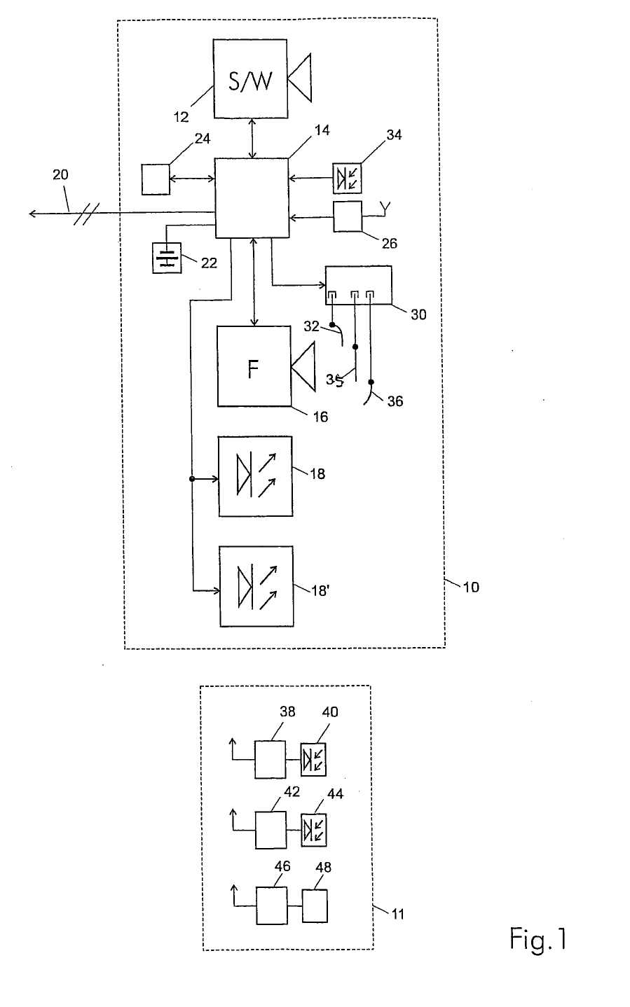

FIG. 1 is a principal illustration of a video monitoring device, and

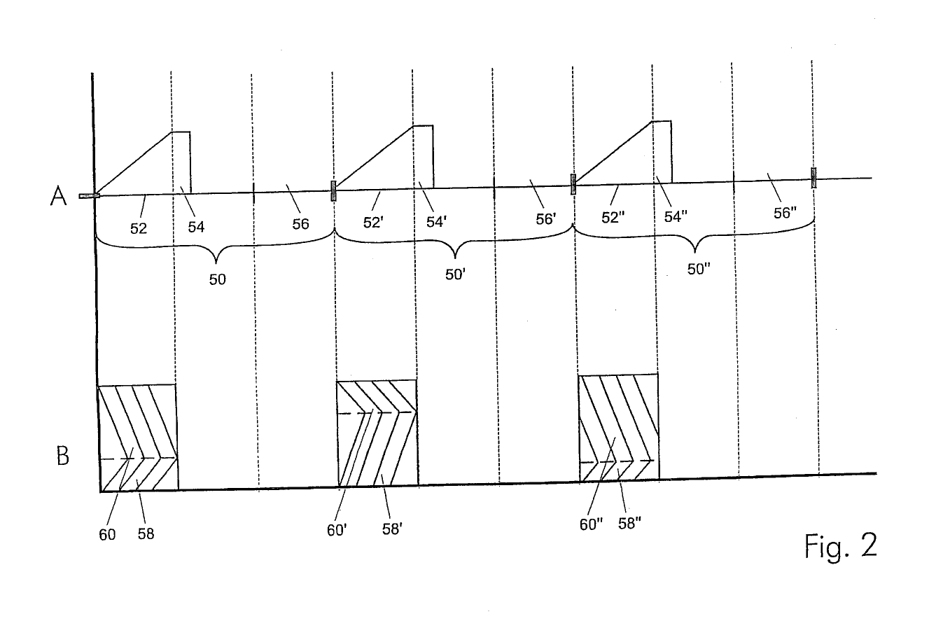

FIG. 2 is a time diagram for showing an exposure phase of a digital camera and switching-on and switching-off pulses of the light source for constant switching-on pulses, and

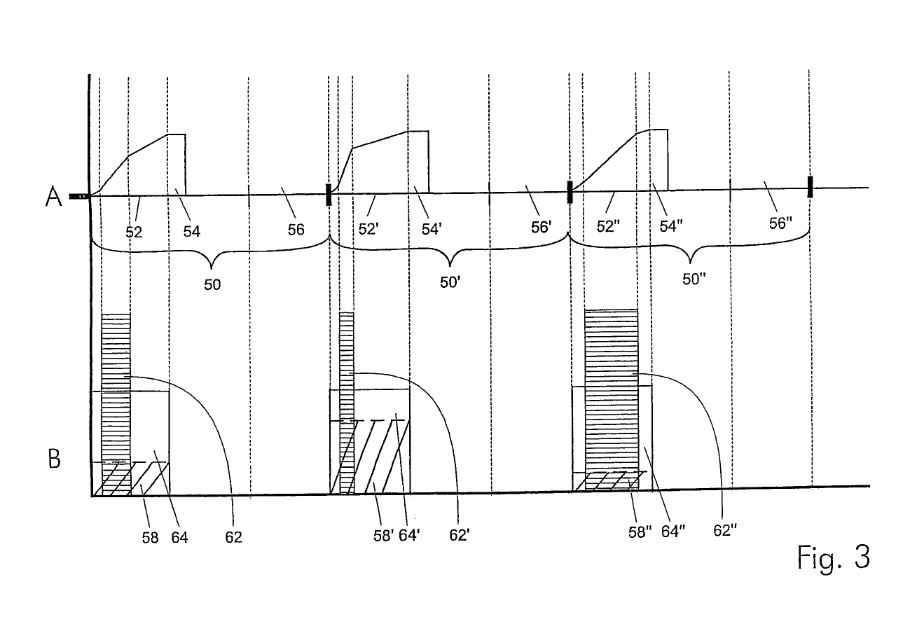

FIG. 3 is a time diagram for showing an exposure phase of a digital camera and switching-on and switching-off pulses of the light source for variable switching-on pulses.

FIG. 1 shows a block circuit diagram of a video monitoring device comprising a camera and illumination device 10 and an external sensor arrangement 11.

The camera and illumination device 10 comprises a black-and-white camera 12, a colour camera 16, a plurality of light sources 18, 18′, a control circuit 14, a data store 24, an energy buffer 22, an Ethernet connection 20, an environmental light sensor 34, a sensor receiver 26 as well as an actuator 30 with apertures 32 and 36 and a grey filter 35.

The sensor arrangement 11 comprises brightness sensors 40 and 44 as well as sensors from the set of acoustic sensors, temperature sensors, movement sensors, which, for example, are illustrated in a sensor 48. The sensors 40, 44, 48 are each connected with transmitters 38, 42 and 46, and the corresponding sensor signals are transmitted to the sensor receiver 26 of the camera and illumination device 10 via transmitters 38, 42, 46.

Image sequences received by the black-and-white camera 12 or the colour camera 16 are processed by the control circuit 14 and compressed and then transferred remotely via the Ethernet connection 20 to a receiving station. The same Ethernet connection 20 is used for the energy supply of all the components arranged in the camera and illumination device 10. The environmental brightness is captured by the environmental light sensor 34 and transmitted to the control circuit 14. The control circuit uses the environmental brightness to select one of the two digital cameras 12 or 16. For a high environmental brightness the digital colour camera 16 is selected, whilst for a low environmental brightness the digital black-and-white camera 12 is selected.

If there are no relevant monitoring results, the digital colour camera 16 and the digital black-and-white camera 12 as well as the remaining components with the exception of the sensor receiver 26 are in a non-operating state. Relevant events are monitored by the sensors 40, 44, 48 of the sensor arrangement 11 in locations which presumably could be event locations. In these locations changes in brightness can be monitored using the brightness sensors 40 and 44, and the general sensor 48 representing a plurality of different sensors can be used to monitor acoustic changes, changes in temperature or movements. Sensor signals are then transmitted to the sensor receiver 26 via the downstream transmitters 38, 42 and 46 to activate the colour camera 16 or the black-and-white camera 12 via the control circuit 14 and to place these into a non-operating state or into an operating state.

In case the environmental light sensor 34 senses a low environmental brightness, the black-and-white camera 12 is selected. The control circuit 14 serves to determine the amount of light required for a high-contrast shot. If the natural quantity of light from the environment is not sufficient, the light sources 18, 18′ are activated in order to supplement, through illumination of the object, the natural quantity of light from the environment at the location of the object to the extent where the light quantity required for a high-contrast shot is achieved.

This can be done in steps by activating and pulsed on- and off-switching of a number of light sources 18, 18′ out of a total number or by controlling the pulse-pause-ratio between switching-on pulse and switching-off pulse of light sources 18, 18′ so that they are switched on only during an exposure phase of the digital black-and-white camera 12. During the switching-on pulse the light sources 18, 18′ may, for a short time, require a higher electrical input power than is made available on average via the Ethernet connection 20. To compensate for the peak power from the light sources 18, 18′ or the actuator 30, a buffer 22 is provided which can be shaped as a capacitor or accumulator.

Preferably the light quantity required for a high-contrast shot is computationally ascertained by the control computer 14 to give a maximum contrast in a selected image section which is directed at particularly relevant areas of the object to be monitored. It may happen that other image sections are over- or underexposed. In order to achieve a balanced optimal contrast in the overall image, several images are buffered in the store 24 with a resulting image then being generated from the images in the buffer, in which over- and underexposed image sections are replaced by high-contrast image sections of other images.

In case of a high environmental brightness the digital colour camera 16 is activated by means of the environmental light sensor 34 and the control circuit 14. In contrast to the digital black-and-white camera 12 this camera provides additional image data due to the colour, but requires a higher environmental brightness in order to utilise these additional data. In this case the light sources may remain switched off.

For a high environmental brightness due to irradiation from the sun there is the danger that some areas of the image are overexposed due to direct irradiation from the sun or reflections caused by reflecting surfaces. In this case apertures 32 and 36 or a grey filter 35 may be inserted into the path of the rays of the digital colour camera 16 under the control of the control circuit 14 by means of an actuator 30. Examples for the apertures to be provided are an aperture 32 for rays coming from above and an aperture for rays coming from below. It is also feasible to provide further apertures which may be inserted from the side. These measures support the normally provided apertures in the digital colour camera 16, in order to purposefully counteract an excessive incidence of light which cannot be compensated for by the normal aperture.

Although not shown in the drawing, corresponding apertures may also be inserted into the path of the rays of the digital black-and-white camera 12 by means of an additional actuator, for example for ambient light, reflections of ambient light from a reflecting surface or for moon light.

FIGS. 2 and 3 show a time progression of the recorded image and the illumination during 3 image changing periods of a digital black-and-white camera 12.

Sections A and B each show image changing periods 50, 50′ and 50″. These image changing periods 50, 50′ and 50″ are each divided into exposure phases 52, 52′, 52″, capturing phases 54, 54′, 54″ and processing phases 56, 56′ and 56″. On the y-axis in section A the respective charging state of an image sensor cell is shown over time. In section B the light quantity which leads to a corresponding charge of an image sensor cell of the digital black-and-white camera 12, is indicated.

Shown here are three different residual light quantities 58, 58′ and 58″, which are caused by different environmental brightnesses. These light quantities are supplemented by additional light quantities 60, 60′ and 60″ of light sources 18, 18′ resulting in the light quantity required for a high-contrast shot being provided by the light quantity resulting from residual light and light generated by the light sources 18, 18′.

FIG. 2 is based on the switching-on pulse duration of light sources 18, 18′ being equal to the duration of the exposure phase 52, 52′, 52″ within the image changing periods 50, 50′ and 50″ of the digital black-and-white camera 12.

FIG. 3 shows an alternative, where the switching-on pulse duration 62, 62′ and 62″ of light sources 18, 18′ is shorter than the duration of exposure phase 52, 52′, 52″ and where the residual light quantity is supplemented on the basis of the environmental brightness to achieve the required light quantity by choosing the appropriate pulse-pause-ratio between switching-on and switching-off pulses of light sources 18, 18′. The switching-on pulses 62, 62′ and 62″ lead to a discontinuous increase in the charges of the light sensor cells. Ultimately, however, the same charge states are achieved in terms of obtaining the average light quantity required. The light quantities additionally provided by the switching-on pulses 62, 62′ and 62″ each correspond to the light quantities 64, 64′ and 64″ when averaged, respectively, across the exposure phases 52, 52′ and 52″.

1. A method for controlling a video monitoring device comprising at least one digital camera, an event sensor, an exposure adjusting device with at least one light source and an Ethernet connection, wherein the light source is supplied with energy via an accumulator, a battery, via a remote feed or the Ethernet connection and switched on and off in a pulsed fashion by a control circuit of the digital camera, whereby the switching-on and switching-off pulses are synchronized with an exposure phase within the image changing period of the digital camera.

2. The method according to claim 1, wherein the light quantity required for a high-contrast shot in at least one selected image section is ascertained by the control circuit of the digital camera and a number ascertained for obtaining the required light quantity from a total number of light sources are simultaneously activated and switched on and off in a pulsed fashion.

3. The method according to claim 2, wherein the useful lives of the light sources are adjusted to one another in that activation of the light sources, for less than the total number of simultaneously activated light sources, is distributed evenly in turn among all light sources of the total number.

4. The method according to claim 1, wherein the switching-on pulse duration of the light sources is equal to the duration of the exposure phase within the image changing period of the digital camera.

5. The method according to claim 1, wherein the control circuit of the digital camera is instrumental in ascertaining a light quantity required for a high-contrast shot in at least one selected image section and therefrom a pulse-pause ratio dimensioned for achieving the required light quantity between switching-on and switching-off pulses of the at least one light source, whereby the switching-on pulse duration of the light sources is shorter than the duration of the exposure phases within the image changing period of the digital camera.

6. The method according to claim 1, wherein the required light quantity is ascertained by evaluating the contrast of the at least one selected image section of previously captured images.

7. The method according to claim 1, wherein light quantities exceeding the required light quantity are reduced by reducing means from the set of apertures and filters in that individual reducing means or a combination of reducing means are mechanically inserted partially or wholly into the path of the rays of the at least one digital camera by means of actuators controlled by the control circuit of the at least one digital camera.

8. The method according to claim 1, wherein several images are additionally captured with a light quantity differing from the required light quantity and stored in a buffer of the camera and wherein thereupon an image resulting from the buffered images is generated in that overexposed and underexposed image sections of individual images are replaced by high-contrast image sections of other images.

9. The method according to claim 1, wherein by means of at least one internal event sensor the at least one digital camera is placed from an energy-saving non-operating state into an operating state and at the end of the event, is returned to the non-operating state with or without a time delay.

10. The method according to claim 1, wherein the at least one digital camera, when an event occurs, is placed, by means of at least one external event sensor arranged closely to a presumed event location in a selected image section, from an energy-saving non-operating state into an operating state and at the end of the event, is returned into the non-operating state with or without a time delay or following an image analysis.

11. The method according to claim 9, wherein, after the at least one digital camera has been placed into the operating state, an image analysis of the event is carried out with the operating state being maintained if the event is confirmed, whilst, if the event is not confirmed, the digital camera is placed into the non-operating state.

12. The method according to claim 9, wherein events are selected from the set of changes in brightness, acoustic changes, changes in temperature, movements.

13. The method according to claim 1, wherein, of the at least one camera, a digital black-and-white camera is selected for a low environmental brightness or a digital color camera is selected for a high environmental brightness by means of the control circuit depending upon the environmental brightness captured by a sensor.

14. The method according to claim 1, wherein power peaks of the light sources and/or actuators are buffered by an accumulator or a capacitor.
